(19) United States
(12) Patent Application Publication
(10) Pub. No.: US 2012/0327969 A1
(43) Pub. Date: Dec. 27, 2012

(54) TEST METHOD AND DEVICE FOR TESTING HEAT SINK

(75) Inventors: HUNG-CHOU CHAN, Tu-Cheng (TW); XIAO-FENG MA, Shenzhen City (CN)

(73) Assignees: HON HAI PRECISION INDUSTRY CO., LTD., TU-CHENG (TW); HONG FU JIN PRECISION INDUSTRY (SHENZHEN) CO., LTD., SHENZHEN CITY (CN)

(21) Appl. No.: 13/316,457

(22) Filed: Dec. 10, 2011

(30) Foreign Application Priority Data
Jun. 27, 2011 (CN) 201110174794.X

(51) Int. Cl. G01N 25/20

(52) U.S. Cl. 374/43

(57) ABSTRACT

A test device for testing a heat sink including a plurality of fasteners is provided. Each fastener includes a screw and a spring sleeved on the screw. The test device includes a base, a heater arranged on the base, and a temperature sensor staying in contact with the heater and configured to detect a temperature of the heater. A timer counts a time duration during which the temperature of the heater changes from a first value to a second value. The heat sink is connected to the base by the screws and resides on the heater.

### BACKGROUND

1. Technical Field

The present disclosure relates to test devices, and particularly, to a method and test device for testing a heat sink.

2. Description of Related Art

The miniaturization and high integration have been rapidly advancing for semiconductors used in electronic equipment, especially for semiconductors represented by CPUs of information processing equipment. Accordingly, the amount of heat generation has been increasing. Thus, it is important and necessary to provide a method and device to test whether a heat sink for the CPU is mounted in a suitable position where the heat sink can dissipate the heat generated by the CPU effectively.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric, exploded view of a test device for testing a heat sink, in accordance with a first embodiment.

FIG. 2 is an isometric, exploded view of a test device for testing a heat sink, in accordance with a second embodiment.

FIG. 3 is an isometric, exploded view of a test device for testing a heat sink, in accordance with a third embodiment.

FIG. 4 is an isometric, assembled view of an adjustable support of FIG. 3.

FIG. 5 is an isometric, assembled view of a test device and a heat sink of FIG. 3.

### DETAILED DESCRIPTION

Embodiments of the present disclosure will now be described in detail with reference to the accompanying drawings.

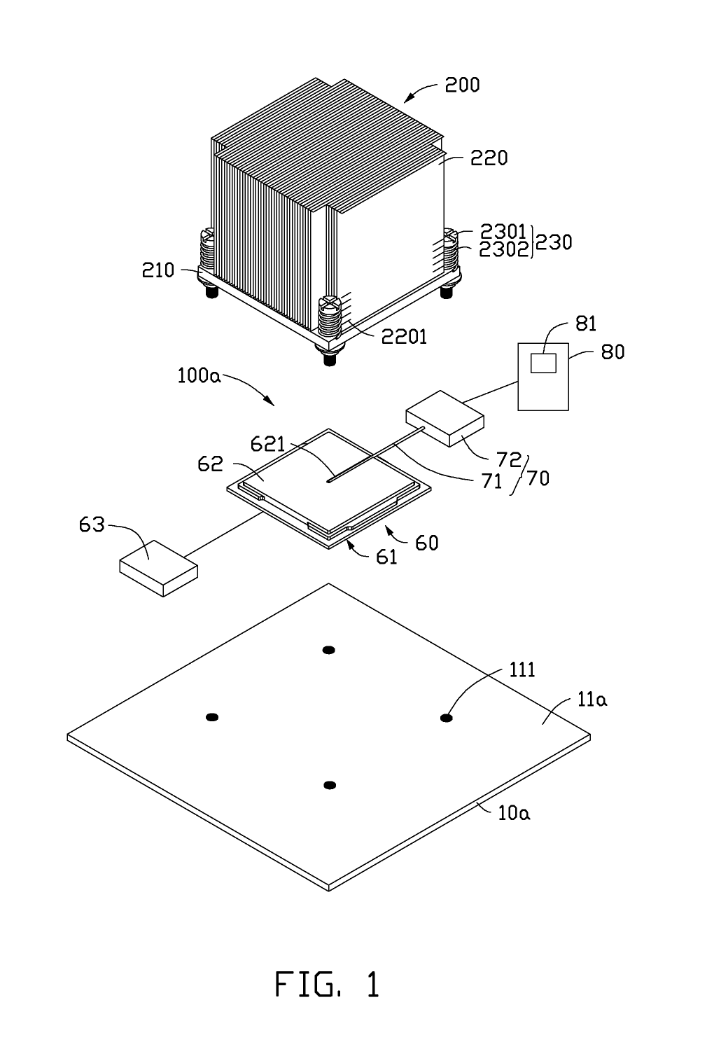

Referring to FIG. 1, a test device 100a for testing a heat sink 200 according to a first embodiment is shown. The test device 100a includes a base 10a, a heater 60, a temperature sensor 70, and a timer 80. The heat sink 200 includes a bottom plate 210, a number of thermally conductive sheets 220 on the bottom plate 210, and a number of fasteners 230. Each fastener 230 includes a screw 2301 and a spring 2302 sleeved on the screw 2301. The spring 2302 includes two opposite ends abutting against both the head of the screw 2301 and the bottom plate 210.

The base 10a is a planar plate, and includes a top surface 11a and defines a number of threaded holes 111 for a threaded connection with the screws 2301. The heater 60 includes a lower surface 61, an upper surface 62, and a power source 63. The heater 60 is arranged on the base 10a, with the lower surface 61 contacting the top surface 11a. The power source 63 provides electrical power that is converted into thermal power.

The temperature sensor 70 detects the temperature of the heater 60. In the embodiment, the sensor 70 includes a thermocouple wire 71 and a display 72 for a display of the detected temperature value. The heater 60 defines a groove 621 to receive the thermocouple wire 71.

The timer 80 is connected to the temperature sensor 72 and can output a time value counted by the timer 80 to the display 72, for display. The timer 80 includes a controller 81 and an input unit to allow a user to set a start parameter and a stop parameter. The controller 81 starts the timer 80 when the temperature detected by the temperature sensor 70 reaches to the first start parameter, and stops the timer 80 when the temperature detected by the temperature sensor 70 reaches to the stop parameter. In an alternative embodiment, one or more buttons may be used to start/stop the timer 80.

When in use, the heater 60 is first started. The temperature of the heater 60 detected by the temperature sensor 70 is displayed on the display 72. When the temperature of the heater 60 reaches to a first value, the heater 60 is stopped and the controller 81 starts the timer 80. The timer 80 then starts to count a time duration during which the temperature of the heater 60 drops from the first value to a second value. The controller 81 then stops the timer 80 when the temperature of the heater 60 drops to the second value. A user can then turn the screw to further compress the spring 2302, which increases the push force applied to the bottom plate 210. The pressure force between the heat sink 200 and the heater 60 then increases. An indication line 2201 can be made on the heat sink to indicate the position of the head of each screw 2301. The steps stated above can be repeated several times to obtain a set of time durations during which the temperature of the heater 60 drops from the first value to a second value. The indication lines 2201 corresponding to the shortest time duration of the obtained data can be determined. When mounting the heat sink 200 on a circuit board, a user can turn the screws 2301 as indicated by the determined indication lines 2201. As a result, the heat sink 200 can dissipate the heat generated by the components such as a central processing unit in the shortest time.

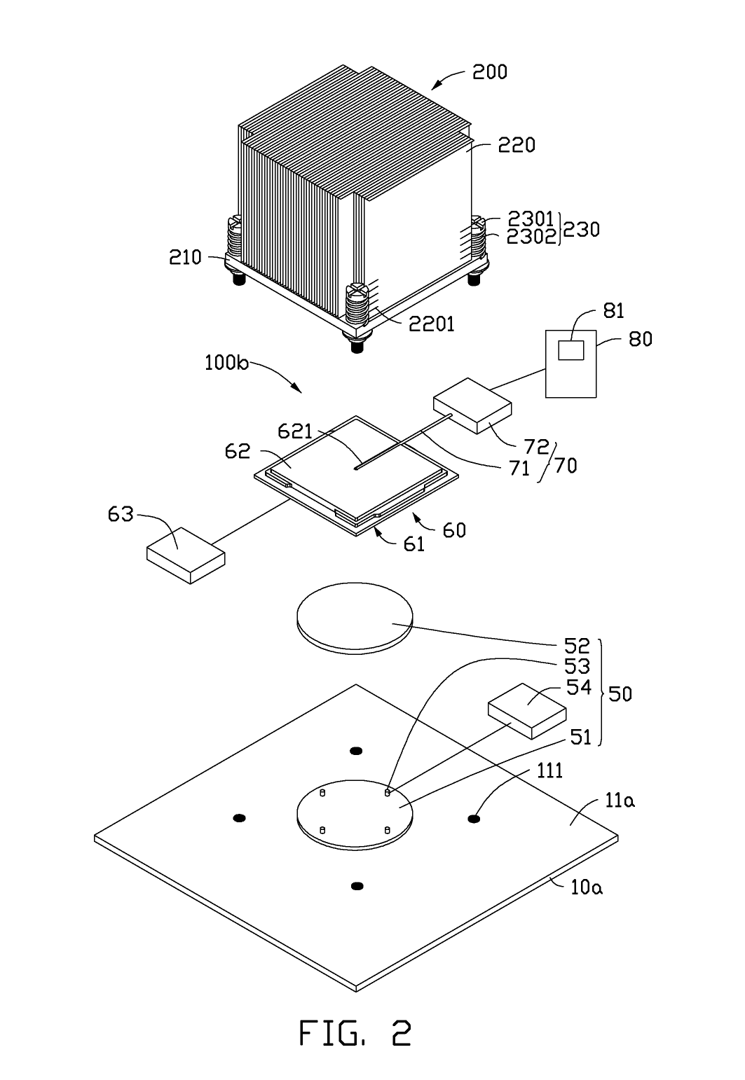

Referring to FIG. 2, a test device 100b according to a second embodiment is shown. The test device 100b includes all the elements of test device 100a and includes additionally a pressure sensing device 50. The pressure sensing device 50 includes an upper plate 52, a lower plate 51, a number of piezoelectric sensors 53, and a display 54.

The piezoelectric sensors 53 are arranged between the plates 51 and 52. The lower plate 51 is arranged on the base 10a and the upper plate 52 contacts the bottom of the heater 60. The pressure force detected by the piezoelectric sensors 53 can reflect the pressure force between the heat sink 200 and the heater 60, and can be displayed on the display 54.

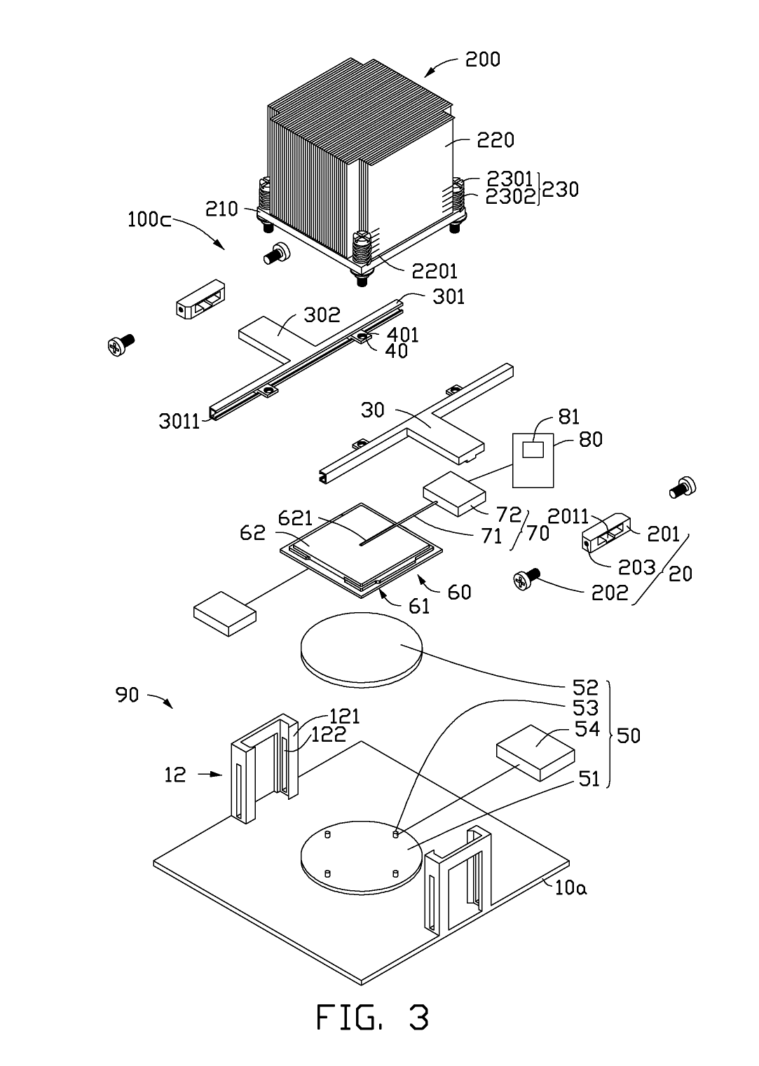

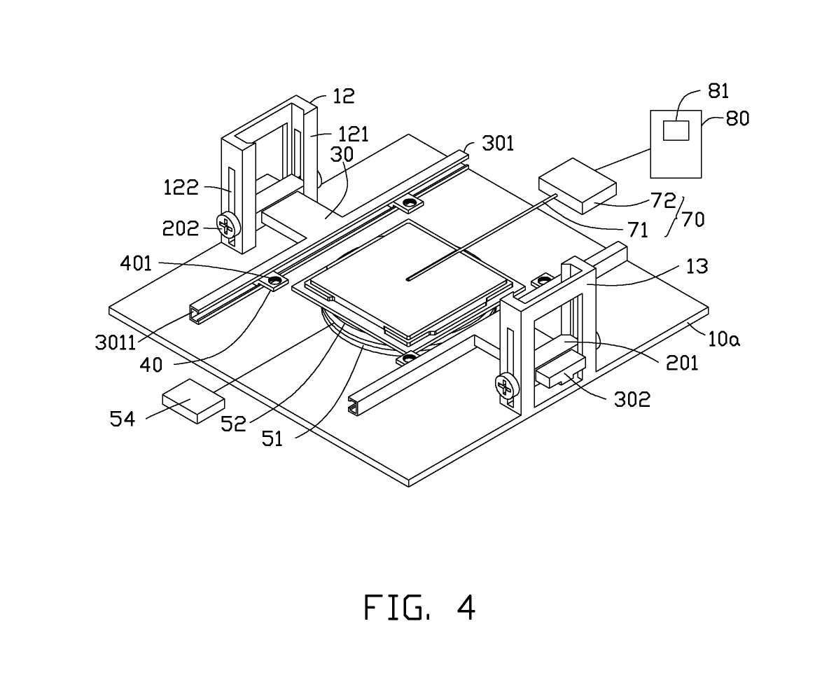

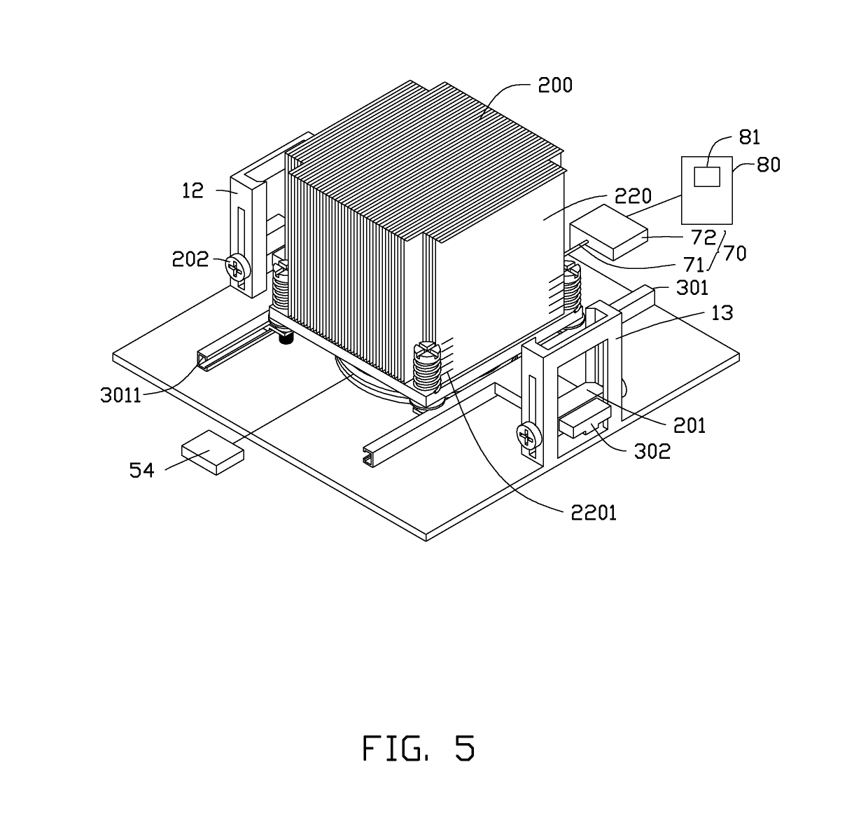

Referring to FIGS. 3-5, a test device 100c according to a third embodiment is shown. The test device 100c includes all the elements of test device 100b and further includes two adjustable supports 90. Each support 90 includes a frame 12, a slider 20, a support arm 30, and a plurality of slidable tabs 40. The frame 12 includes two bars 121 protruding from the base 10a. Each bar 121 defines a groove 122 extending along its heightwise direction.

The slider 20 includes a slidable bar 201 and two screws 202. Each screw 202 passes through one groove 122 of the frame 12 and is screwed into a threaded hole 203 defined in one end of the slidable bar 201, thereby slidably connecting the slider 20 to the frame 12. The slider 20 can slide along the grooves 122 in a first direction substantially perpendicular to the base 10a. The slider 20 further defines an opening 2011.

The support arm 30 is T-shaped and includes a base plate 302 and an elongated bar 301 formed at an end of the base plate 302. The base plate 302 passes through the opening 2011 and can slide along the opening 2011 in a second direction substantially parallel to the base 10a. The elongated bar 301 defines a guide groove 3011 to receive some of the tabs 40. The tabs 40 can slide along the guide groove 3011 in a third direction substantially parallel to the base 10a and perpendicular to the second direction. Each tab 40 defines a threaded hole 401 for threaded connection with a screw 2301. The adjustable supports 90 can adapt heat sinks of different sizes.

While various embodiments have been described and illustrated, the disclosure is not to be construed as being limited thereto. Various modifications can be made to the embodiments by those skilled in the art without departing from the true spirit and scope of the invention as defined by the appended claims.

What is claimed is:

1. A test device for testing a heat sink, the heat sink comprising a plurality of fasteners, each fastener comprising a screw and a spring sleeved on the screw, the test device comprising:
a base;
a heater arranged on the base;
a temperature sensor staying in contact with the heater and configured to detect a temperature of the heater; and
a timer configured to measure a time duration during which the temperature of the heater changes from a first value to a second value;
wherein the heat sink is to be connected to the base by the screws and resides on the heater.

2. The test device according to claim 1, wherein the temperature sensor includes a thermocouple wire and a display for displaying a temperature value of the heater, and the heater defines a groove to receive the thermocouple wire therein.

3. The test device according to claim 1, further comprising two adjustable supports, wherein each adjustable support comprises a frame, a slider, a support arm, and a plurality of slidable tabs, the frame protrudes from the base, the slider is slidably connected to the frame and is able to slide along a first direction substantially perpendicular to the base, the support arm is slidably connected to the slider and is able to slide along a second direction substantially parallel to the base, and the slidable tabs are slidably connected to the support arm and are able to slide along a third direction substantially parallel to the base and perpendicular to the second direction, each of the slidable tabs defines a threaded hole to receive an end of one of the screws.

4. The test device according to claim 3, wherein the frame comprises two opposite bars protruding from the base, each bar defining a guide slot, opposite ends of the slider are slidably received in the guide slots.

5. The test device according to claim 3, wherein the slider comprises a body defining an opening, and the support arm comprises a base plate and a elongated bar formed at one end of the base plate and perpendicular to the base plate, the base plate passes through the opening and is guided by the opening to be slidable along the second direction, the elongated bar defines a slide groove to receive some of the slidable tabs.

6. The test device according to claim 1, further comprising a pressure sensing unit arranged on the base under the heater.

7. A method for testing the heat sink of claim 1 utilizing the test device of claim 1, the method comprising:
(a). starting the heater;
(b). stopping the heater when the temperature detected by the temperature sensor reaches to the first value;
(c). starting the counter to count the time duration during which the temperature detected by the temperature sensor drops from the first value to the second value;
(d). screwing the screw of each fastening assembly to change a length of the spring sleeved on the screw, to further change a pressure force between the heat sink and the heater; and
(e). repeating steps (a)-(d) to obtain a plurality of time durations.
